(19) United States
(12) Patent Application Publication
(10) Pub. No.: US 2017/0355149 A1
(43) Pub. Date: Dec. 14, 2017

(54) INSPECTION AND REPAIR OF ADHESIVE-BONDED JOINT USING ULTRASONIC PULSES

(71) Applicant: GM GLOBAL TECHNOLOGY OPERATIONS LLC, Detroit, MI (US)

(72) Inventors: Pei-Chung Wang, Troy, MI (US); Jorge F. Arinez, Rochester Hills, MI (US); Susan M. Smyth, Rochester Hills, MI (US); Zhongxia Liu, Zhengzhou (CN)

(73) Assignee: GM GLOBAL TECHNOLOGY OPERATIONS LLC, Detroit, MI (US)

(21) Appl. No.: 15/599,969

(22) Filed: May 19, 2017

Related U.S. Application Data
(60) Provisional application No. 62/347,371, filed on Jun. 8, 2016.

(51) Int. Cl. B29C 65/08; B29C 73/24; B29C 65/00; G01N 29/265; G01N 29/04; B29C 65/02

(52) U.S. Cl. CPC B29C 65/08; G01N 29/265; G01N 29/04; B29C 73/24; B29C 66/951; B29C 65/02; B29C 66/90; G01N 2291/02854

(57) ABSTRACT

A method of inspection and repair of a joint in an assembly. The joint is formed by a first work piece and a second work piece. An adhesive placed between the first and second work pieces to define the joint. The assembly includes an ultrasonic welding device including an ultrasonic horn configured to deliver ultrasonic energy to the joint. A controller is operatively connected to the ultrasonic welding device. The controller includes a processor and tangible, non-transitory memory on which is recorded instructions for executing a method of inspecting and repairing the adhesive-bonded joint. The controller is programmed to deliver a first ultrasonic pulse (P1) to the joint, via the ultrasonic welding device, and determine an adhesive coverage (AC) based at least partially on the first ultrasonic pulse (P1).

### CROSS-REFERENCE TO RELATED APPLICATIONS

This application claims the benefit of U.S. Provisional Patent Application No. 62/347,371 filed on Jun. 8, 2016, the disclosure of which is hereby incorporated by reference.

### INTRODUCTION

The disclosure relates generally to inspection and repair of adhesive-bonded joints using ultrasonic pulses. In many industries, adhesive bonding is employed for bonding many different types of materials. For example, adhesive bonding is used to bond polymeric composites, which are lightweight, conformable and durable. The adhesive employed may have missing portions over time. A method of inspection to determine the state of an adhesive-bonded joint is desirable, including subsequent repair of a discrepant joint.

### SUMMARY

A method of inspection and repair of a joint in an assembly. The joint is formed by a first work piece and a second work piece. An adhesive placed between the first and second work pieces to define the joint. The assembly includes an ultrasonic welding device including an ultrasonic horn configured to deliver ultrasonic energy to the joint. A controller is operatively connected to the ultrasonic welding device. The controller includes a processor and tangible, non-transitory memory on which is recorded instructions for executing a method of inspecting and repairing the adhesive-bonded joint. The controller is programmed to deliver a first ultrasonic pulse (P1) to the joint, via the ultrasonic welding device, and determine an adhesive coverage (AC) based at least partially on the first ultrasonic pulse (P1).

The first work piece and the second work piece may be composed of identical materials. The first work piece and the second work piece may be composed of dissimilar materials. At least one sensor may be operatively connected to the controller and configured to measure a depth of displacement of the ultrasonic horn in the joint. Determining an adhesive coverage (AC) includes determining if the adhesive is cured. If the adhesive is not cured, the controller is programmed to obtain a depth of displacement of the ultrasonic horn in the joint after delivery of the first ultrasonic pulse (P1), via the at least one sensor. If the adhesive is not cured, the controller is programmed to obtain the adhesive coverage (AC) for the joint based at least partially on the depth of displacement and a first look-up table. If the adhesive is cured, determining an adhesive coverage (AC) includes obtaining an energy delivered to the joint by the first ultrasonic pulse (P1) and obtaining the adhesive coverage (AC) based at least partially on the energy delivered by the joint and a second look-up table.

The controller may be further programmed to determine if the adhesive coverage (AC) is at or below a predefined threshold coverage (TC). If the adhesive coverage (AC) is at or below the threshold coverage (TC), the controller is programmed to determine the energy of a second ultrasonic pulse (P2) based at least in part on the adhesive coverage (AC) and a third look-up table.

If the adhesive coverage (AC) is at or below the threshold coverage (TC), the controller is programmed to deliver the second ultrasonic pulse (P2), via the ultrasonic welding device, to the joint under a compressive force to form a weld at the joint, thereby repairing the joint. The predefined threshold coverage (TC) may be selected such that a joint strength (S_{U,TC}) of an un-repaired bonded joint at the threshold coverage is less than or equal to a joint strength (S_{R,TC}) of a repaired welded joint at the threshold coverage [S_{U,TC}≦S_{R,TC}]. The predefined threshold coverage may be 50%.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary view of a joint assembly having a controller, a first work piece, a second work piece and an adhesive bonding the first and second work pieces, showing application of a first ultrasonic pulse;

FIG. 2 is a schematic top view of the adhesive of FIG. 1;

FIG. 3 is a schematic fragmentary view of the joint assembly of FIG. 1, showing application of a second ultrasonic pulse;

FIG. 4 is a flowchart of a method stored on and executable by the controller of FIG. 1; and

FIG. 5 is an example graph showing joint strength (in pounds), for the given joint configuration, on the vertical axis and percentage adhesive coverage on the horizontal axis.

### DETAILED DESCRIPTION

Referring to the drawings, wherein like reference numbers refer to like components, FIG. 1 is a schematic illustration of an assembly 10 which may take many different forms and include multiple and/or alternate components. Referring to FIG. 1, the assembly 10 includes a first work piece 12 and a second work piece 14. The first work piece 12 and the second work piece 14 may be composed of identical materials. The first work piece 12 and the second work piece 14 may be composed of dissimilar materials. The first work piece 12 may be composed of carbon fiber nylon composite and the second work piece 14 may be composed of nylon. In one example, the first work piece 12 and the second work piece 14 are both composed of thermoplastics. In another example, the first work piece 12 is composed of a thermoplastic and the second work piece 14 is composed of a metal. In another example, the first work piece 12 and the second work piece 14 are both composed of metals. A spacer 16, such as an energy director for example, may be positioned between the first work piece 12 and the second work piece 14 to create a gap 17. As shown in FIG. 1, an adhesive 18 is positioned between the first work piece 12 and the second work piece 14, to bond the first and second work pieces 12, 14 and define an adhesive-bonded portion 20, referred to herein as “joint 20”.

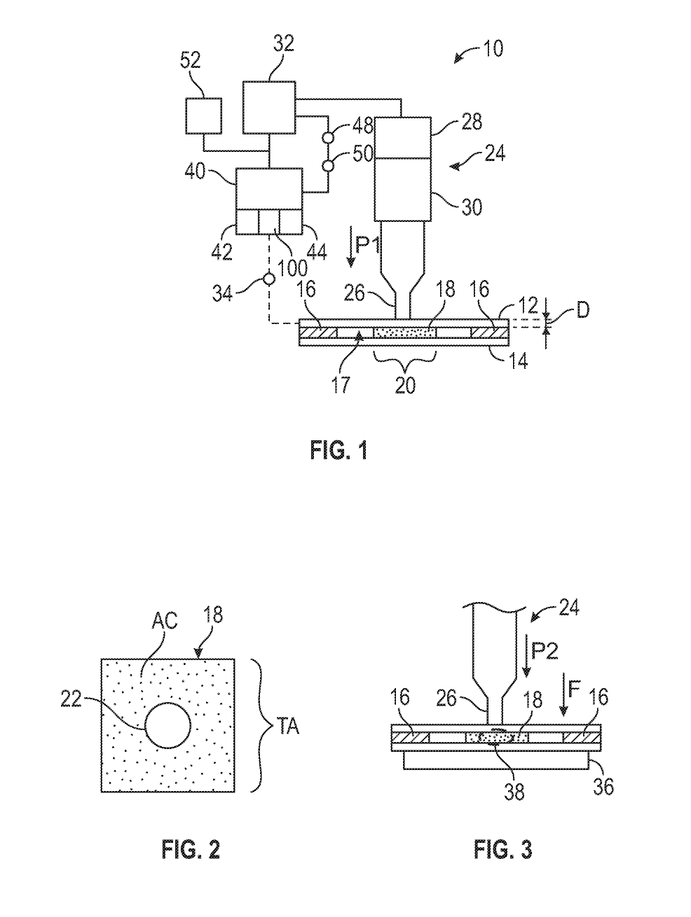

FIG. 2 is a schematic top view of the adhesive 18. At the time of application, the adhesive 18 is spread over a “total area,” shown in FIG. 2 as “TA.” While the total area TA is a rectangle in the example shown, it may be of whatever shape or size as needed. For a variety of reasons, portions of the adhesive 18 may wear off over time, shown in FIG. 2 as missing portion 22. The size, shape and location of the missing portion 22 in the total area TA may be selected based on the application at hand. The remaining portion of the total area TA that continues to have the adhesive 18 is labeled as adhesive coverage (AC) (shown lightly shaded).

Referring to FIG. 1, the assembly 10 includes an ultrasonic welding device 24. The ultrasonic welding device 24 is configured to apply ultrasonic acoustic vibrations to the joint 20. The ultrasonic welding device 24 may include an ultrasonic horn 26, a transducer 28 and an amplifier 30. A power source 32 may be operatively connected to the ultrasonic welding device 24. The ultrasonic welding device 24 may include other electronic or acoustic components suitable for the ultrasonic welding device 24.

Referring to FIG. 1, the transducer 28 may be configured to transform an output voltage of the power source 32 into a mechanical vibration or amplitude. This vibration may be sent through the amplifier 30, which can increase or decrease the mechanical vibration that is coming from the transducer 28. The ultrasonic horn 26 is configured to efficiently transfer the acoustic energy from the transducer 28 (via the amplifier 30) into the joint 20.

Referring to FIG. 1, the ultrasonic welding device 24 is configured to deliver a first ultrasonic pulse P1 to the joint 20. The ultrasonic horn 26 is brought into contact with the first work piece 12 and the ultrasonic welding device 24 is energized for a predetermined period of time. The first ultrasonic pulse P1 causes localized melting of the first and second work pieces 12, 14, and decomposing (or degrading) of adhesive 18, due to heat generated at the faying interfaces. Depending on the state of the adhesive 18, the heat generated by the ultrasonic vibration may cause the ultrasonic horn 26 to be displaced or “sink” into the joint 20. The assembly 10 may include a depth sensor 34 operatively connected to the controller 40 and configured to measure the depth of displacement (labeled “D” in FIG. 1) of the ultrasonic horn 26 in the joint 20.

FIG. 3 is a schematic fragmentary view of the application of a second ultrasonic pulse P2 to the joint 20. The ultrasonic horn 26 is brought into contact with the first work piece 12. Subsequently, the ultrasonic welding device 24 is energized for a predetermined period of time to cause the transfer of ultrasonic energy to the joint 20 and resulting in localized melting. For a brief dwell period, the first and second work pieces 12, 14 are retained under a compressive force F between the ultrasonic horn 26 and a fixed anvil 36, thereby allowing the softened localized material to become rigid and form a weld 38.

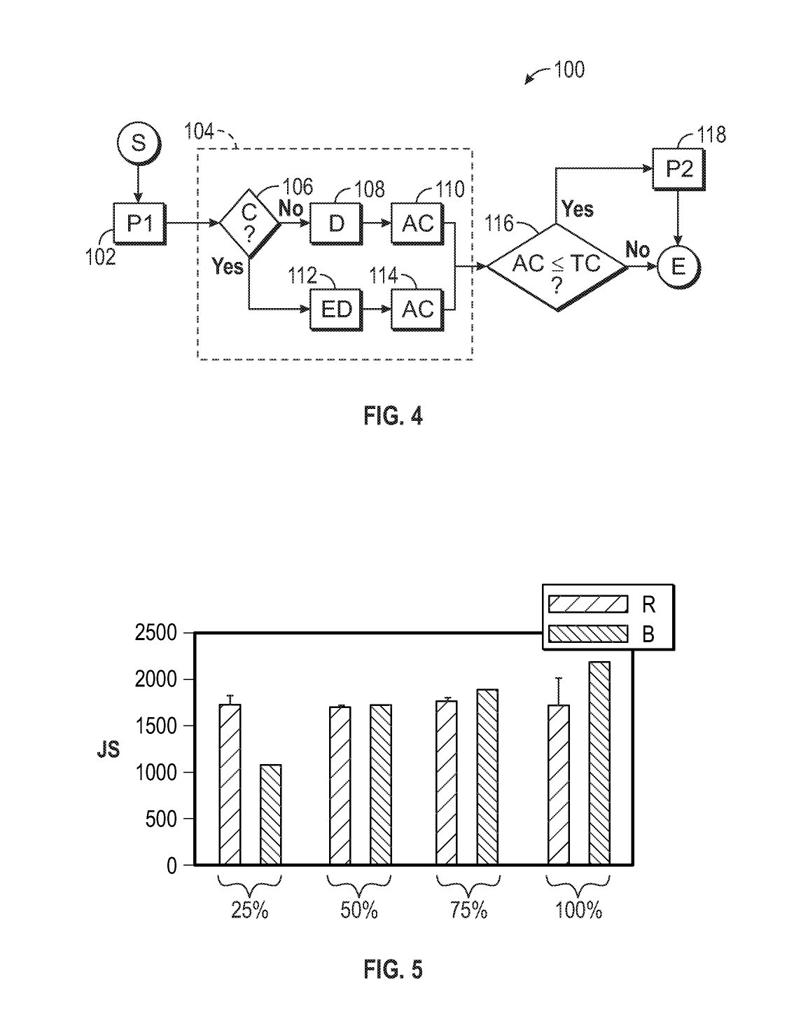

Referring to FIG. 1, a controller 40 is operatively connected to the ultrasonic welding device 24. The controller 40 includes a processor 42 and tangible, non-transitory memory 44 on which is recorded instructions for executing a method 100, described below with reference to FIG. 4, of inspecting and repairing the (adhesive-bonded) joint 20. The method 100 may include repairing discrepant joints based on the inspection results. A discrepant joint is defined as a joint 20 differing undesirably from a target configuration or coverage or not meeting target mechanical properties such as strength or fatigue life.

The controller 40 of FIG. 1 may include other driver circuits (not shown) and other components for controlling the ultrasonic welding device 24. The ultrasonic horn 26 may be formed with a shape, cross-section and length suitable to the application at hand. The length of the ultrasonic horn 26 is selected such that there is mechanical resonance at the desired ultrasonic frequency of operation. The specific frequency of ultrasound produced by the transducer 28 may vary based on the application. The frequency of ultrasound vibration may range from 15 to 300 kHz.

Referring now to FIG. 4, a flowchart of the method 100 stored on and executable by the controller 40 of FIG. 1 is shown. The start and end of method 100 are shown by “S” and “E,” respectively. Method 100 need not be applied in the specific order recited herein and it is to be understood that some steps may be eliminated. The execution of the method 100 improves the functioning of the assembly 10 in many ways.

Method 100 may begin with block 102. In block 102, the controller 40 is programmed to deliver a first ultrasonic pulse (P1) to the joint 20, via the ultrasonic welding device 24. As shown in FIG. 2A, the first ultrasonic pulse (P1) causes localized melting of the first and second work pieces 12, 14, and decomposing (or degrading) of adhesive 18, due to the absorption of ultrasonic vibration energy. The first ultrasonic pulse (P1) is configured such that no weld is formed at the joint 20, for example, by being of insufficient intensity.

In block 104, the controller 40 is programmed to determine an adhesive coverage (AC) of the joint 20 based at least partially on the first ultrasonic pulse (P1). Block 104 includes sub-blocks 106, 108, 110, 112 and 114, described below. In sub-block 106, the controller 40 is programmed to determine if the adhesive 18 is cured. Curing is defined as a process, such as a chemical reaction or physical action, which results in a tougher or stronger adhesive bond. An adhesive bond may be cured via a baking step where the adhesive 18 is subject to an elevated temperature for a predetermined amount of time. The controller 40 may determine if the adhesive 18 is cured or not by a method available to those skilled in the art. For example, a user can determine this from visual inspection or knowledge of the history of the joint 20, and convey the information to the controller 40 via a user interface 52 (see FIG. 1). Also, a physical test available to those skilled in the art may be used determine the state of the adhesive 18, including but not limited to, a joint strength or displacement depth D of the ultrasonic horn 26.

If the adhesive 18 is not cured, the method 100 proceeds from sub-block 106 to sub-block 108, where the controller 40 is programmed to obtain the depth of displacement D of the ultrasonic horn 26 in the joint 20 after delivery of the first ultrasonic pulse (P1). The measurement of the depth of displacement D may be made via the depth sensor 34. As mentioned above the measurement of displacement depth (D in FIG. 1) of the ultrasonic horn 26 may also be used to identify the state of the adhesive 18 in sub-block 106. For a given energy of the ultrasonic pulse, the depth displacement D of an adhesive 18 that is cured would be smaller than an adhesive 18 that is not cured.

The method 100 then proceeds to sub-block 110, where the controller 40 is programmed to obtain the adhesive coverage (AC) for the joint 20 based at least partially on the depth of displacement D (from block 108) and a first look-up table. The values of the first look-up table (and second and third look-up tables described below) may be obtained via calibration or in a test cell or laboratory. The first, second and third look-up tables may be a type of data repository or storage medium. Interpolation may be employed to determine values in between the data points in the respective look-up tables. A non-limiting example of a first look-up table is shown below in Table 1:

TABLE 1

| Depth of Displacement | |
|---|---|
| (mm) | Adhesive Coverage (AC) (%) |
| 0.14 | 0 |
| 0.20 | 42 |
| 0.26 | 85 |
| 0.33 | 95 |
| 0.42 | 100 |

If the adhesive 18 is cured, the method 100 proceeds from sub-block 106 to sub-block 112, the controller 40 is programmed to obtain an energy delivered (ED) to the joint 20 by the first ultrasonic pulse (P1). The energy delivered (ED) to the joint 20 may be obtained based at least partially on the power delivered to the joint 20, e.g., via integration of power delivered over time. The power source 32 may be rated by the peak power it can deliver, which may vary from a few hundred watts to several kilowatts. Based on a constant power output, a 0.5-second pulse from a 1.5-kW ultrasonic welding device would deliver 750 joules of energy. The assembly 10 may include a voltage sensor 48 and a current sensor 50 to assess the voltage and current, respectively, delivered to the ultrasonic welding device 24. The assembly 10 may include other sensors or employ other methods or models available to those skilled in the art to obtain the energy delivered (ED) to the joint 20 by the first ultrasonic pulse (P1).

The method 100 proceeds to sub-block 114, where the controller 40 is programmed to obtain the adhesive coverage (AC) based at least partially on the energy delivered (ED) to the joint 20 and a second look-up table. The values of the second look-up table may be obtained via calibration or in a test cell or laboratory. An example of a second look-up table is shown below in Table 2:

TABLE 2

| Energy Delivered | Adhesive coverage (AC) % |
|---|---|
| ED1 | 0 |
| ED2 | 25 |
| ED3 | 50 |
| ED4 | 75 |
| ED5 | 100 |

In block 116, the controller 40 is programmed to determine if the adhesive coverage (AC) is at or below a predefined threshold coverage (TC). The predefined threshold coverage (TC) may be selected for the application at hand. The predefined threshold coverage (TC) may be selected such that a joint strength (S_{U,TC}) of an un-repaired bonded joint at the threshold coverage is less than or equal to a joint strength (S_{R,TC}) of a repaired welded joint at the threshold coverage [S_{U,TC}≦S_{R,TC}], FIG. 5 is an example graph showing joint strength “JS” (in pounds) on the vertical axis and percentage adhesive coverage on the horizontal axis. FIG. 5 is shown for illustrative purposes and is intended as a non-limiting example. Referring to FIG. 5, the joint strengths of an un-repaired bonded joint at 25%, 50%, 75% and 100% adhesive coverage are about 1100, 1700, 1900 and 2200 pounds, respectively. Referring to FIG. 5, the joint strengths of a repaired welded (previously bonded and then repaired via ultrasonic pulse welding) joint at 25%, 50%, 75% and 100% adhesive coverage are about 1700, 1700, 1800 and 1700 pounds, respectively. In this example, the predefined threshold coverage (TC) may be set to 50%.

If the adhesive coverage (AC) is above the threshold coverage (TC), the method is ended. If the adhesive coverage (AC) is at or below the threshold coverage (TC), the method proceeds to block 118, where the controller 40 is programmed to determine the energy of a second ultrasonic pulse (P2) based at least in part on the adhesive coverage (AC) and a third look-up table. The energy of the second ultrasonic pulse (P2) is required to be of sufficient intensity to form a weld 38 at the joint 20. An example of a third look-up table is shown below in Table 3:

TABLE 3

| | Energy of Second Pulse |
|---|---|
| Adhesive coverage (AC) % | (P2) (Joules) |
| 0 | E1 |
| 25 | E2 |
| 50 | E3 |
| 75 | E4 |

In block 118, the controller 40 is programmed to deliver the second ultrasonic pulse (P2), via the ultrasonic welding device 24, to the joint 20 under a compressive force F. The application of the second ultrasonic pulse (P2) fuses the locations at the faying interfaces between the first and second work pieces 12, 14 and the adhesive 18 to form a weld 38, thereby repairing the joint 20 to a desired joint strength.

The controller 40 of FIG. 1 may include a driver circuit (not shown) for controlling the ultrasonic welding device 24. Referring to FIGS. 1-2, the controller 40 may include a respective computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, punch cards, paper tape, other physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or more desired characteristics from other embodiments, resulting in other embodiments not described in words or by reference to the drawings. Accordingly, such other embodiments fall within the framework of the scope of the appended claims.

1. An assembly configured to inspect and repair a joint formed by a first work piece, a second work piece and an adhesive placed between the first and second work pieces to define the joint, the assembly comprising:
an ultrasonic welding device including an ultrasonic horn configured to deliver ultrasonic energy to the joint;
a controller operatively connected to the ultrasonic welding device;
wherein the controller includes a processor and tangible, non-transitory memory on which is recorded instructions for executing a method of inspecting and repairing the adhesive-bonded joint;
wherein the controller is programmed to:
deliver a first ultrasonic pulse (P1) to the joint, via the ultrasonic welding device; and
determine an adhesive coverage (AC) based at least partially on the first ultrasonic pulse (P1).

2. The assembly of claim 1, wherein the first work piece and the second work piece are composed of identical materials.

3. The assembly of claim 1, wherein the first work piece and the second work piece are composed of dissimilar materials.

4. The assembly of claim 1, further comprising:
at least one sensor operatively connected to the controller and configured to measure a depth of displacement of the ultrasonic horn in the joint;
wherein said determining an adhesive coverage (AC) includes:
determining if the adhesive is cured;
if the adhesive is not cured, obtaining a depth of displacement of the ultrasonic horn in the joint after delivery of the first ultrasonic pulse (P1), via the at least one sensor; and
if the adhesive is not cured, obtaining the adhesive coverage (AC) for the joint based at least partially on the depth of displacement and a first look-up table.

5. The assembly of claim 4, wherein said determining an adhesive coverage (AC) includes:
if the adhesive is cured, obtaining an energy delivered to the joint by the first ultrasonic pulse (P1) and obtaining the adhesive coverage (AC) based at least partially on the energy delivered by the joint and a second look-up table.

6. The assembly of claim 1, wherein the controller is further programmed to:
determine if the adhesive coverage (AC) is at or below a predefined threshold coverage (TC);
if the adhesive coverage (AC) is at or below the threshold coverage (TC), determine an energy of a second ultrasonic pulse (P2) based at least in part on the adhesive coverage (AC) and a third look-up table.

7. The assembly of claim 6, wherein the predefined threshold coverage is 50%.

8. The assembly of claim 6, wherein the controller is programmed to:
if the adhesive coverage (AC) is at or below the threshold coverage (TC), deliver the second ultrasonic pulse (P2), via the ultrasonic welding device, to the joint under a compressive force to form a weld at the joint, thereby repairing the joint.

9. The assembly of claim 6, wherein the predefined threshold coverage (TC) is selected such that a joint strength (S_{U,TC}) of an un-repaired bonded joint at the threshold coverage is less than or equal to a joint strength (S_{R,TC}) of a repaired welded joint at the threshold coverage [S_{U,TC}c ≦S_{R,TC}].

10. A method of inspection and repair of a joint in an assembly having an ultrasonic welding device, a first work piece, a second work piece and an adhesive bonding the first and second work pieces to define the joint, the method comprising:
delivering a first ultrasonic pulse (P1) to the joint, via the ultrasonic welding device;
determining an adhesive coverage (AC) of the joint based at least partially on the first ultrasonic pulse (P1);
determining if the adhesive coverage (AC) is at or below a predefined threshold coverage (TC);
if the adhesive coverage (AC) is at or below a threshold coverage, determining an energy of a second ultrasonic pulse (P2) based at least in part on the adhesive coverage (AC); and
if the adhesive coverage (AC) is at or below the threshold coverage, applying the second ultrasonic pulse (P2), via the ultrasonic welding device, to the joint under a compressive pressure to form a weld at the joint, thereby repairing the joint.

11. The method of claim 10, wherein said determining an adhesive coverage (AC) of the joint includes:
determining if the adhesive is cured;
if the adhesive is not cured, obtaining a depth of displacement of the ultrasonic horn in the joint after delivery of the first ultrasonic pulse (P1), via the at least one sensor; and
if the adhesive is not cured, obtaining the adhesive coverage (AC) for the joint based at least partially on the depth of displacement and a first look-up table.

12. The method of claim 10, wherein said determining an adhesive coverage (AC) includes:
determining if the adhesive is cured;
if the adhesive is cured, obtaining an energy delivered to the joint by the first ultrasonic pulse (P1) and obtaining the adhesive coverage (AC) based at least partially on the energy delivered by the joint and a second look-up table.

13. An assembly configured to inspect and repair a joint formed by a first work piece, a second work piece and an adhesive placed between the first and second work pieces to define the joint, the assembly comprising:
an ultrasonic welding device including an ultrasonic horn configured to deliver ultrasonic energy to the joint;
a controller operatively connected to the ultrasonic welding device;
at least one sensor operatively connected to the controller and configured to measure a depth of displacement of the ultrasonic horn in the joint;
wherein the controller includes a processor and tangible, non-transitory memory on which is recorded instructions for executing a method of inspecting and repairing the adhesive-bonded joint;
wherein the controller is programmed to:
deliver a first ultrasonic pulse (P1) to the joint, via the ultrasonic welding device; and
determine an adhesive coverage (AC) based at least partially on the first ultrasonic pulse (P1), including determining if the adhesive is cured.

14. The assembly of claim 13, wherein said determining an adhesive coverage (AC) includes:
if the adhesive is not cured, obtaining a depth of displacement of the ultrasonic horn in the joint after delivery of the first ultrasonic pulse (P1), via the at least one sensor; and
if the adhesive is not cured, obtaining the adhesive coverage (AC) for the joint based at least partially on the depth of displacement and a first look-up table.

15. The assembly of claim 14, wherein said determining an adhesive coverage (AC) includes:
if the adhesive is cured, obtaining an energy delivered to the joint by the first ultrasonic pulse (P1) and obtaining the adhesive coverage (AC) based at least partially on the energy delivered by the joint and a second look-up table.

16. The assembly of claim 15, wherein the controller is further programmed to:
determine if the adhesive coverage (AC) is at or below a predefined threshold coverage (TC);
if the adhesive coverage (AC) is at or below the threshold coverage (TC), determine an energy of a second ultrasonic pulse (P2) based at least in part on the adhesive coverage (AC) and a third look-up table.

17. The assembly of claim 16, wherein the controller is programmed to:
if the adhesive coverage (AC) is at or below the threshold coverage (TC), deliver the second ultrasonic pulse (P2), via the ultrasonic welding device, to the joint under a compressive force to form a weld at the joint, thereby repairing the joint.

18. The assembly of claim 17, wherein the predefined threshold coverage (TC) is selected such that a joint strength (S_{U,TC}) of an un-repaired bonded joint at the threshold coverage is less than or equal to a joint strength (S_{R,TC}) of a repaired welded joint at the threshold coverage [S_{U,TC}≦S_{R,TC}].
